(19) United States
(12) Patent Application Publication
(10) Pub. No.: US 2026/0250150 A1
(43) Pub. Date: Aug. 27, 2026

(54) LITHIUM AND MANGANESE-RICH PRECURSOR SYNTHESIS

(71) Applicant: FORD GLOBAL TECHNOLOGIES, LLC, Dearborn, MI (US)

(72) Inventors: Aaron ROWE, LaSalle (CA); Eunsung LEE, Novi, MI (US); Chi PAIK, Grosse Ile, MI (US)

(21) Appl. No.: 19/060,241

(22) Filed: Feb. 21, 2025

(51) Int. Cl. C01G 53/502; B01J 10/00; H01M 4/505

(52) U.S. Cl. CPC C01G 53/502; B01J 10/00; H01M 4/505; C01P 2006/11; C01P 2006/40

(57) ABSTRACT

A method for producing a lithium manganese-rich electrode is presented. The method includes purging a reactor vessel and liquid reagents with nitrogen gas to establish a substantially oxygen-free atmosphere, followed by mixing a metal sulfate solution and a basic reagent solution to initiate a co-precipitation reaction that forms metal hydroxide and metal oxyhydroxide nuclei. Subsequently, a mixture of oxygen and nitrogen is introduced into the reactor vessel atmosphere to regulate the average primary particle size of the resulting metal oxyhydroxide particles. This controlled mixture is maintained to produce polycrystalline secondary metal oxyhydroxide particles.

### TECHNICAL FIELD

In at least one aspect, positive electrode active materials for lithium-ion batteries are provided.

### BACKGROUND

Nickel-cobalt-manganese (NCM) cathode active materials (CAM) are widely used in lithium-ion batteries due to their high energy density and reliability. These materials are typically produced using polycrystalline NCM CAM precursors (PCAM), which consist of sub-micron primary particles aggregated into spheroidal micron-sized secondary particles. The particle size distribution, morphology, and porosity of the secondary particles directly influence the electrochemical performance of the resulting CAM. Lithium and manganese-rich (LMR) NCM materials, characterized by a high manganese content, present opportunities for improving battery performance.

### SUMMARY

A method for producing a lithium manganese-rich electrode is provided. This method includes purging a reactor vessel and liquid reagents of oxygen by nitrogen gas sparging to establish a substantially oxygen-free atmosphere, mixing a metal sulfate solution and a basic reagent solution into the substantially oxygen-free atmosphere to initiate a co-precipitation reaction forming metal hydroxide and metal oxyhydroxide nuclei, introducing oxygen and nitrogen into the reactor vessel's atmosphere to control the average primary particle size of the resulting metal oxyhydroxide particles, and maintaining a mixture of oxygen and nitrogen to produce polycrystalline secondary particles composed of metal oxyhydroxide particles. The oxygen to nitrogen ratio may be controlled between 1:99 and approximately 5:95, and introduced through a sparging nozzle. The oxygen-nitrogen mixture may also be introduced into at least one reagent solution such as a metal sulfate solution, ammonium hydroxide solution, or sodium hydroxide solution. Adjusting the flow rate of oxygen relative to nitrogen during transitions between seeding and nucleation to agglomeration and growth phases may reduce average primary particle size by 20-50%. The resulting secondary particles may exhibit a tap density greater than 2.2 g/cm³ and a D50 particle size distribution between 8-12 micrometers. Primary particles may have an average diameter of 100-500 nm, with a controlled distribution reducing overall impedance of the final cathode active material. A controlled calcination step may transform the particles into a lithium manganese-rich nickel cobalt manganese layered oxide cathode active material with stable cycling performance at elevated voltages.

A method for forming a lithium manganese-rich nickel cobalt manganese layered oxide active material is provided. This method includes mixing metal sulfate solutions and basic solutions in an oxygen-free reactor vessel to initiate a co-precipitation reaction forming metal hydroxide and metal oxyhydroxide particles, regulating the supply of oxygen and nitrogen gas to control particle formation, and adjusting the oxygen gas supply to produce high-density secondary particles. Increasing oxygen content during early nucleation may reduce primary particle size, while decreasing oxygen during later growth phases may prevent excessive particle enlargement. Controlling the parameters to a pH of 10-12, reaction temperature to 50-60° C., and residence time to 8-24 hours in conjunction with controlled oxygen gas introduction may further refine the particle size distribution. The resulting cathode active material may achieve a discharge capacity of at least 250 mAh/g when cycled between 2.0V and 4.6V and may have a tap density greater than 2.0 g/cm³. The material may follow the formula Li_{1.01 to 1.15}Mn_{0.50 to 0.62}Ni_{0.25 to 0.49}Co_{0.0 to 0.10}O₂.

An apparatus for producing a lithium manganese-rich nickel cobalt manganese cathode is provided. This apparatus includes a reaction vessel with inlets and outlets configured to purge all solutions and the vessel headspace with nitrogen gas to create substantially oxygen-free conditions prior to initiating a co-precipitation reaction, a gas mixing system configured to introduce controlled oxygen and nitrogen gas ratios into the vessel, and a sparging element configured to disperse gas mixtures into a slurry within the vessel. The apparatus may further include real-time sensors and a control module to monitor dissolved oxygen content, particle size distribution, and slurry density, enabling dynamic adjustments of oxygen gas flow relative to nitrogen gas flow during the co-precipitation process.

### BRIEF DESCRIPTION OF THE DRAWINGS

FIG. 1A is a schematic view, of a reactor with a single inlet configuration;

FIG. 1B is a schematic view, of a reactor with an inline mixing configuration;

FIG. 2 is a flowchart of a process for precursor synthesis; and

FIG. 3 is a schematic view, of a reactor with a stirred tank configuration;

FIG. 4A is a coaxial nozzle diagram in a retracted position; and

FIG. 4B is a coaxial nozzle diagram in an extended position.

### DETAILED DESCRIPTION

The preferred compositions, methods, and embodiments described herein represent the current best practices known to the inventors. The provided figures are illustrative and not necessarily to scale. These embodiments serve as examples and are not intended to limit the scope of the disclosure. Instead, they provide a representative framework for understanding the invention and guide those skilled in the art in applying it in various ways.

Unless explicitly stated otherwise, when a chemical structure includes a substituent on a moiety (e.g., aryl, alkyl), the substituent is understood to apply to a broader chemical structure encompassing the given structure. All percentages, parts, and ratios are by weight unless stated otherwise. The term “polymer” encompasses oligomers, copolymers, terpolymers, and similar structures. Molecular weights refer to weight-average molecular weight unless otherwise indicated. References to a group or class of materials as suitable or preferred imply that mixtures of two or more members of the group are also suitable or preferred. Descriptions of chemical constituents refer to their state at the time of addition and do not preclude interactions among them once mixed. The first definition of an acronym or abbreviation applies throughout and includes grammatical variations of the term. Measurements of a property use the same techniques referenced elsewhere in the document unless stated otherwise.

Singular terms such as “a,” “an,” and “the” include plural referents unless the context dictates otherwise. For example, reference to a singular component includes multiple components. This disclosure is not limited to specific embodiments or methods, as components and conditions may vary. The terminology used herein is for descriptive purposes and is not intended to limit the scope of the disclosure.

The term “comprising” is synonymous with “including,” “having,” “containing,” or “characterized by,” and is open-ended, allowing for unrecited elements or steps. The term “composed of” may mean “including” or “consisting of,” depending on context, and often indicates an object is formed from specified materials.

Integer ranges explicitly include all integers within the range. For example, the range 1-10 includes 1, 2, 3, and so on, up to 10. Similarly, ranges such as 1 to 100 include all intermediate integers. Additionally, when a range is specified, intermediate values based on increments of one-tenth of the difference between the range's upper and lower limits may also serve as alternative bounds. For instance, the range 1.1 to 2.1 includes values like 1.2, 1.3, and so forth.

Unless explicitly stated otherwise, all numerical values and ranges related to quantities, measurements, percentages, weights, or similar references should be understood to include the term “about.” For example, a value of “5 wt. %” is interpreted as “about 5 wt. %,” accounting for standard variations in measurement techniques, material properties, or intended functionality. Ranges such as “100 to 200 units” should be read as “about 100 to about 200 units.”

The term “positive electrode” refers to a battery cell electrode from which current flows during discharge, also known as a “cathode.” Conversely, a “negative electrode” refers to the electrode receiving current during discharge, often called an “anode.”

The term “cell” or “battery cell” refers to an electrochemical cell comprising at least one positive electrode, one negative electrode, an electrolyte, and a separator. The term “battery” or “battery pack” refers to an energy storage device composed of one or more battery cells. In some configurations, a battery pack includes multiple cells connected in series or parallel.

The term “specific capacity” denotes the capacity per unit mass of the active material in the electrode, measured in milliamp hours per gram (mAh/g).

The present disclosure relates to LMR CAM with the formula Li_{1.01 to 1.15}Mn_{0.50 to 0.62}Ni_{0.25 to 0.49}Co_{0.0 to 0.10}O₂, and their PCAM, in the form of metal hydroxides or oxyhydroxides. The disclosed methods address challenges in producing PCAM with reduced primary particle size, enhancing the electrochemical performance of the resulting CAM. By controlling oxygen and nitrogen levels during key reaction phases, the process enables particle size control, resulting in increased porosity, density, and conductivity.

A method for producing LMR NCM CAM with increased electrochemical performance by controlling the primary particle size of its precursors during synthesis is contemplated. The method relies on tailoring the oxygen (O₂) and nitrogen (N₂) content in the reactor atmosphere during stages of the co-precipitation reaction.

The synthesis begins by establishing a substantially oxygen-free environment in the reactor vessel to initiate the co-precipitation reaction. This is achieved by purging the reactor vessel, liquid reagents, and associated equipment, such as reflux condensers, with N₂ gas. Sparging with N₂ gas ensures the removal of dissolved oxygen and prevents unwanted oxidation of transition metal ions during the initial stages of the reaction. This purging step achieves consistent control over the nucleation and growth processes. Once an oxygen-free atmosphere is established, a metal sulfate solution containing manganese, nickel, and cobalt sulfates is mixed with a basic reagent solution, such as ammonium hydroxide (NH₄OH) or sodium hydroxide (NaOH), within the reactor vessel. This initiates a co-precipitation reaction to form a mixture of metal hydroxide (M(OH)₂) and metal oxyhydroxide (MOOH) nuclei.

After nucleation, a controlled mixture of O₂ and N₂ gases is introduced into the reactor atmosphere. The oxygen content in the gas mixture is precisely regulated, with volumetric or molar ratios ranging from 1:99 to 5:95 (O₂:N₂). This controlled introduction of O₂ influences the formation of metal oxyhydroxide particles, which exhibit different crystallographic and morphological properties compared to pure hydroxide particles. Adjusting the O₂ concentration during this stage allows precise control over the size and distribution of primary particles. The gas mixture may be introduced into the reactor in one or more ways. In one approach, a pre-mixed O₂/N₂ gas blend is introduced through a nozzle strategically placed within the reactor, with the nozzle position adjustable to be immersed in the reactor slurry or located in the headspace above the slurry. In another approach, the O₂/N₂ gas mixture is bubbled through one or more of the starting reagent solutions, such as the metal sulfate solution or ammonium hydroxide solution, via inline mixing before these reagents are added to the reactor vessel. This ensures uniform dissolution of O₂ into the liquid phase and provides enhanced control over local oxidative conditions.

As the reaction progresses from the nucleation to the agglomeration and growth phases, the flow rate of O₂ relative to N₂ can be adjusted dynamically. During the nucleation phase, a lower O₂ concentration is preferred to limit rapid oxidation and promote the formation of smaller primary particles. In contrast, during the agglomeration phase, a higher O₂ concentration can facilitate the growth and densification of secondary particles while maintaining uniform morphology and porosity.

The controlled introduction of O₂ results in primary particles with average diameters ranging from 100 nm to 500 nm. These smaller primary particles aggregate into dense, polycrystalline secondary particles with a tap density greater than 2.2 g/cm³ and a D50 particle size distribution of 8 to 12 micrometers. The resulting secondary particles exhibit high structural uniformity, optimized porosity, and increased contact points between primary particles, improving the overall electrochemical performance of the final CAM.

The LMR NCM precursors produced using the disclosed method are subjected to a controlled calcination step to convert the precursors into the final cathode active material. The calcination process involves heating the precursor material in an oxygen-rich atmosphere to form the layered oxide structure of LMR NCM with the general formula Li_{1.01 to 1.15}Mn_{0.50 to 0.62}Ni_{0.25 to 0.49}Co_{0.0 to 0.10}O₂. Other specific general formulas may be Li_{1.05}Mn_{0.55}Ni_{0.40}Co_{0.05}O₂, Li_{1.10}Mn_{0.60}Ni_{0.28}Co_{0.02}O₂, Li_{1.01}Mn_{0.50}Ni_{0.49}Co_{0.0}O₂, Li_{1.15}Mn_{0.62}Ni_{0.25}Co_{0.08}O₂, and Li_{1.05}Mn_{0.57}Ni_{0.38}Co_{0.05}O₂.

This layered structure facilitates lithium-ion transport during battery cycling. The calcination step can be further optimized by controlling parameters such as temperature, typically between 800° C. and 900° C., duration between 10 to 20 hours, and ramp rates to ensure uniform phase formation and to reduce defects. The resulting LMR NCM CAM has a discharge capacity of at least 250 mAh/g when cycled between 2.0V and 4.6V, with increased cycling stability at elevated voltages.

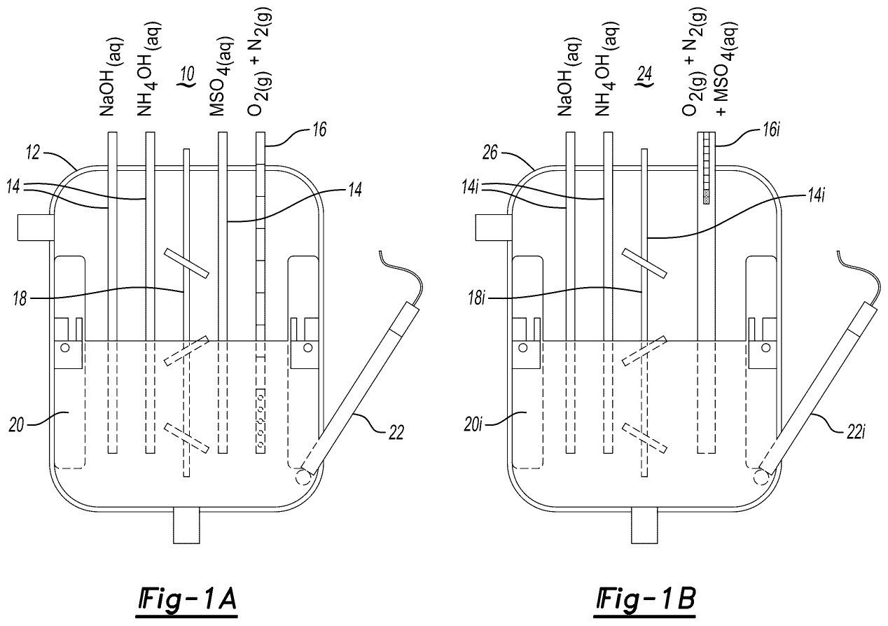

In FIG. 1A, a reactor system 10 is in a first configuration where the O₂/N₂ gas mixture is introduced directly into the reactor vessel via a single inlet nozzle. This configuration includes a reactor vessel 12 that holds the reaction mixture, with reagent solution inlets 14 for introducing chemical solutions such as aqueous NaOH or aqueous NH₄OH. The O₂/N₂ gas inlet 16 enables the controlled introduction of a pre-mixed blend of gases directly into the reactor environment. The reagent solution inlets 14 include a metal sulfate solution inlet which allows for the introduction of transition metal precursors. Mixing within the vessel is facilitated by an agitator with impellers 18, while baffles 20 prevent vortex formation to ensure efficient mixing. A pH sensor 22 continuously monitors the pH of the reaction mixture to maintain optimal conditions for the co-precipitation process.

In FIG. 1B, the reactor system is an alternative configuration 24 where the O2/N2 gas mixture is introduced into the reactor via inline mixing with one or more reagent solutions before entry. A reactor vessel 26 similarly holds the reaction mixture, with reagent solution inlets 14i for introducing pre-mixed chemical and gas solutions. The integrated inline mixing system combines O₂/N₂ gas from a O₂/N₂ gas inlet 16i with the metal sulfate solution in the reactor vessel 26 before introduction into the reactor. Mixing is facilitated by an agitator with impellers 18i, while baffles 20i maintain proper slurry dynamics. A pH sensor 22i monitors the pH during the reaction process. The reactors 10 and 24 may include support brackets which may provide stability to the system, and a vessel outlet port may allow for product collection.

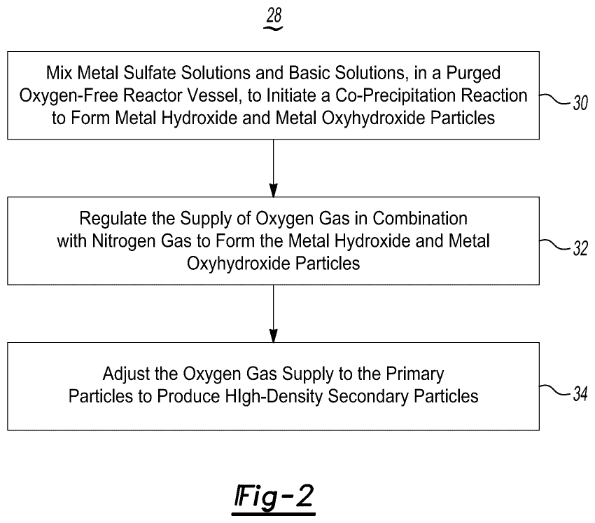

FIG. 2 is a flowchart 28 of steps in the process for forming a LMR NCM layered oxide active material. A first step 30 involves mixing metal sulfate solutions containing controlled ratios of manganese, nickel, and cobalt sulfates with basic solutions such as ammonium hydroxide or sodium hydroxide within a purged oxygen-free reactor vessel. This initiates a co-precipitation reaction that results in the formation of metal hydroxide and metal oxyhydroxide particles. The oxygen-free environment is helpful during this initial nucleation phase to ensure controlled particle formation and establish preferred conditions for the subsequent growth stages.

In a second step 32, the process involves regulating the supply of oxygen gas in combination with nitrogen gas to control the formation of the metal hydroxide and metal oxyhydroxide particles. This step controls the primary particle size, with oxygen to nitrogen ratios typically maintained between 1:99 to 5:95. The control of the oxidative environment during this stage significantly influences the crystallization behavior and morphological development of the forming particles.

A final step 34 focuses on adjusting the oxygen gas supply to the primary particles to produce high-density secondary particles through controlled agglomeration and growth. This step is essential for achieving the desired morphological characteristics, including tap density greater than 2.2 g/cm³ and optimal D50 particle size distribution between 8-12 micrometers. The control of oxygen concentration during this stage maintains uniform particle growth and optimal internal porosity of the secondary particles, which directly impacts the electrochemical performance of the final cathode active material.

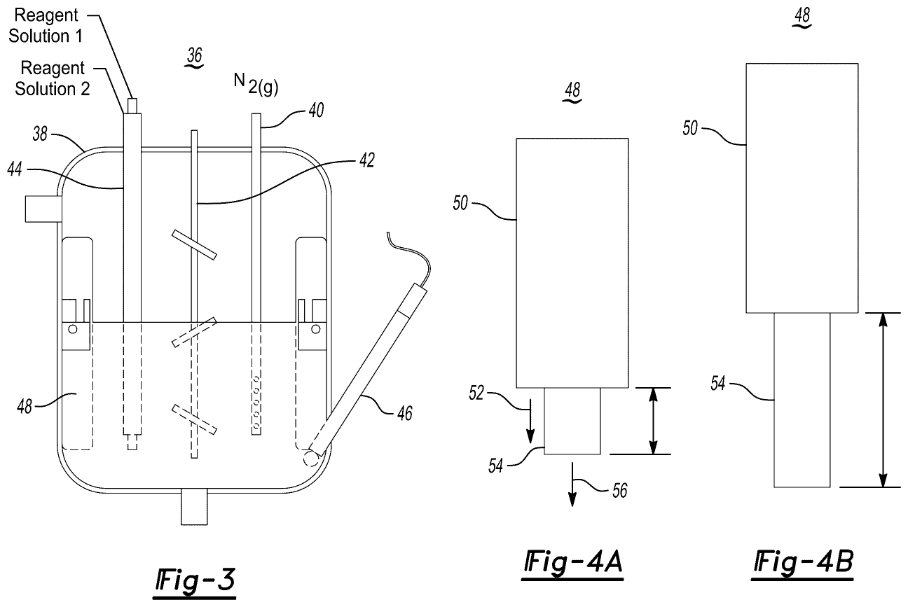

FIG. 3 shows a reactor 36 with a stirred tank configuration used for the synthesis of LMR CAM materials with the Li, Mn, Ni, Co compositions of the general formula: Li_{1.01 to 1.15}Mn_{0.50 to 0.62}Ni_{0.25 to 0.49}Co_{0.0 to 0.10}O₂ and their corresponding PCAM metal hydroxide/oxyhydroxides. The reactor vessel 38 contains a controlled environment where reagents are introduced, mixed, and reacted under specific conditions. A gas inlet 40 introduces nitrogen gas N₂ or an O₂-N₂ mixture to regulate dissolved oxygen levels during co-precipitation. The agitator with impellers 42 maintains uniform mixing, preventing sedimentation and promoting consistent particle growth. A coaxial inlet nozzle 44 allows for the controlled introduction of reagents, such as metal sulfate and basic solutions, facilitating precise reaction conditions. The NCM precursors are made in the chemical reactor 36, within which a metal salt reagent solution (MSO4(aq), where M is equal to Ni 30 Co+Mn=1) and a basic solution containing both a precipitant (NaOH(aq)) and a complexant (NH₄OH(aq)) are introduced to the reactor vessel 38 using a coaxial inlet nozzle 44 configuration. The coaxial inlet nozzle 44 may be placed in different positions in the reactor 36 according to the flow pattern generated within the reactor, including at the point of highest energy input/turbulence within the reactor 36, such that control of the secondary particle size (i.e., D50 value) may be achieved by changing the distance between the orifices of the individual reagent inlets. A pH sensor 46 continuously monitors the reaction environment to maintain optimal pH levels. The reactor 36 also includes a baffle 48 to prevent vortex formation, increasing mixing consistency.

FIGS. 4A and 4B show a coaxial reagent inlet nozzle 48 used in the reactor vessel 38. FIG. 4A shows the coaxial reagent inlet nozzle 48 in a retracted position, where the inner reagent inlet tube 54 is positioned such that its outflow orifice is closer to the outflow orifice of the outer reagent inlet tube 50. Reagent solution 1 exits through the inner reagent inlet tube 54, while reagent solution 2 exits through the outer reagent inlet tube 50. This configuration allows for localized mixing of reagents before they fully disperse into the reactor environment.

FIG. 4B show the coaxial reagent inlet nozzle 48 in an extended position, where the inner reagent inlet tube 54 is moved downward, increasing the distance between its outflow orifice and that of the outer reagent inlet tube 50. This adjustable distance enables precise control over the interaction of reagent solutions at different flow conditions within the reactor vessel 38. The ability to modify this distance allows for fine-tuned mixing conditions that can be optimized to achieve the desired precursor particle size and morphology.

Although exemplary embodiments are described above, they are not intended to represent all possible forms of the disclosure. The language used in the specification is descriptive rather than limiting, and it is understood that various modifications can be made without departing from the spirit and scope of the disclosure. Furthermore, the features of different embodiments may be combined to create additional embodiments of the disclosure.

What is claimed is:

1. A method for producing a lithium manganese-rich electrode comprising:
purging a reactor vessel and liquid reagents of oxygen by nitrogen gas sparging, establishing a substantially oxygen-free atmosphere;
mixing a metal sulfate solution and a basic reagent solution into the substantially oxygen-free atmosphere to initiate a co-precipitation reaction to form metal hydroxide and metal oxyhydroxide nuclei;
introducing oxygen and nitrogen into an atmosphere of the reactor vessel to control average primary particle size of resulting metal oxyhydroxide particles; and
maintaining a mixture of the oxygen and nitrogen to produce polycrystalline secondary particles composed of metal oxyhydroxide particles.

2. The method of claim 1 wherein the oxygen to nitrogen ratio is introduced at a controlled volumetric or molar ratio selected from 1:99 to approximately 5:95 for oxygen to nitrogen.

3. The method of claim 1 wherein the reactor vessel is sealed and oxygen and nitrogen are introduced by directing a gas mixture through a sparging nozzle.

4. The method of claim 1 wherein the mixture is introduced into at least one reagent solution selected from a metal sulfate solution, an ammonium hydroxide solution, and a sodium hydroxide solution.

5. The method of claim 1, further comprising adjusting a flow rate of the oxygen relative to the nitrogen during transition from seeding and nucleation to agglomeration and growth.

6. The method of claim 1 wherein a reduction in average particle size of the metal oxyhydroxide particles is between 20 to 50%.

7. The method of claim 1 wherein introducing oxygen and nitrogen results in dense uniform secondary particles having a tap density greater than 2.2 g/cm³ and a D50 particle size distribution between 8-12 micrometers.

8. The method of claim 1 wherein controlling an oxygen to nitrogen ratio results in primary particles having an average diameter of 100 nm to 500 nm.

9. The method of claim 1 wherein average primary particle size distribution resulting from the oxygen and nitrogen introduction decreases overall impedance of the polycrystalline secondary particles composed of metal oxyhydroxide particles.

10. The method of claim 1, further comprising performing a controlled calcination step after producing the polycrystalline secondary particles composed of metal oxyhydroxide particles, transforming them into a lithium manganese rich nickel cobalt manganese layered oxide cathode active material.

11. A method for forming a lithium manganese rich nickel cobalt manganese layered oxide active material comprising:
mixing metal sulfate solutions and basic solutions, in a purged oxygen-free reactor vessel, to initiate a co-precipitation reaction to form metal hydroxide and metal oxyhydroxide particles;
regulating a supply of oxygen gas in combination with nitrogen gas to form metal hydroxide and metal oxyhydroxide particles; and
adjusting oxygen gas supply to the metal hydroxide and metal oxyhydroxide particles to produce high-density secondary particles.

12. The method of claim 11 wherein increasing the oxygen gas during early nucleation reduces average primary particle size.

13. The method of claim 11, further comprising decreasing oxygen content during later growth phases to limit excessive particle enlargement.

14. The method of claim 11 wherein adjusting pH, reaction temperature, and residence time in conjunction with controlled oxygen gas introduction further refines a particle size distribution of the metal hydroxide and metal oxyhydroxide particles.

15. The method of claim 11 wherein the high-density secondary particles formed have a discharge capacity of at least 250 mAh/g when cycled between 2.0V and 4.6V.

16. The method of claim 11 wherein adjusting the oxygen gas supply to the metal hydroxide and metal oxyhydroxide particles produces secondary particles having a tap density of greater than 2.0 g/cm³.

17. The method of claim 11 wherein process parameters include maintaining a pH between 10-12, a reaction temperature between 50-60 ° C., and a residence time between 8-24 hours.

18. The method of claim 11 wherein the high-density secondary particles follow a general formula: Li_{1.01 to 1.15}Mn_{0.50 to 0.62}Ni_{0.25 to 0.49}Co_{0.0 to 0.10}O₂.

19. An apparatus for producing a lithium manganese rich nickel cobalt manganese cathode comprising:
a reaction vessel with inlets and outlets configured to purge all solutions and vessel headspace with nitrogen gas to create substantially oxygen-free conditions prior to initiating a co-precipitation reaction;
a gas mixing system configured to introduce a controlled mixture of oxygen gas and nitrogen gas at predetermined ratios into the reaction vessel; and
a sparging element configured to disperse gas mixtures into a slurry within the reaction vessel.

20. The apparatus of claim 19, further comprising sensors and a control module to measure dissolved oxygen content, particle size distribution, and slurry density.
